(19) United States
(12) Patent Application Publication
(10) Pub. No.: US 2007/0250476 A1
(43) Pub. Date: Oct. 25, 2007

(54) APPROXIMATE NEAREST NEIGHBOR SEARCH IN METRIC SPACE

(75) Inventor: Samuel M. Krasnik, New York, NY (US)

Correspondence Address: MILES & STOCKBRIDGE PC, 1751 PINNACLE DRIVE, SUITE 500, MCLEAN, VA, 22102-3833, US

(73) Assignee: LOCKHEED MARTIN CORPORATION, Bethesda, MD (US)

(21) Appl. No.: 11/737,992

(22) Filed: Apr. 20, 2007

Related U.S. Application Data
(60) Provisional application No. 60/793,715, filed on Apr. 21, 2006.

(51) Int. Cl. G06F 17/30

(52) U.S. Cl. 707/2

(57) ABSTRACT

A metric space search method can include building a tree data structure representing a database and providing the metric space. The tree can include one or more nodes each having a cluster of one or more data points. Each cluster can have a center data point. During the building of the tree, nodes on one level of the tree can be permitted to overlap by containing mutual data points so long as an overlapping portion does not exhaust a metric subspace on that level. The method can also include searching the tree, one level at a time in a breadth-first manner, to locate a number of nearest neighbors to a query point and generating a list of candidate nearest neighbors during the searching. The method can also include using the list of candidate nearest neighbors to determine whether a portion of the tree is to be searched, and pruning the tree if it is determined that the portion should not be searched. The method can also include storing the list of candidate nearest neighbors as output once a termination condition is met.

The present application claims the benefit of U.S. Provisional Application No. 60/793,715, entitled “Pruning Method for Fast Approximate Nearest Neighbor Search in Metric Spaces,” filed Apr. 21, 2006, which is incorporated herein by reference in its entirety.

The present invention relates generally to data search methods, and, more particularly, to metric space searches.

There may be a wide variety of situations where a collection of data needs to be searched to find a point, or points, that are similar to a given query point. For example, a query point can be compared to data elements in a metric space to find a specified number of nearest neighbors to the query point. This is typically done by determining the metric distance, or degree of difference, between the query point and a given data point in the metric space. Searches can involve complex data with higher intrinsic dimensions, such as images or characters, for example. The searches may also require more than one characteristic or metric distance for each data point to be compared to the query point. Such searches, using conventional methods, can often consume significant amounts of time and resources such as processor cycles and memory. In a real-time application environment, or other environment where a fixed response time is desirable, conventional metric space searches may not be practical because they may be relatively slow, resource-intensive or indeterminate. Embodiments of the present invention have been conceived in light of the above-mentioned characteristics of conventional metric space searches.

One embodiment provides a method for searching a metric space. The method includes building a tree data structure that represents a database and provides the metric space. The tree can have one or more nodes each having a cluster of one or more data points. Each cluster can have a center data point. As the tree is being built, nodes on one level of the tree can be permitted to overlap by containing mutual data points with another node so long as the overlapping portion does not exhaust a metric subspace on that level of the tree. The method also includes searching the tree, one level at a time in a breadth-first manner, to locate a number of nearest neighbors to a query point by determining a metric distance from each center data point to the query point. As the tree is being searched, a list of candidate nearest neighbors to the query point can be generated and used to determine whether portions of the tree should be searched.

The method can also include pruning the tree according to a rule set so as to eliminate a portion of the tree from being considered for further searching. The rule set can include a validity test for pruning a node of the tree that is further away from the query point than a distance in metric space represented by a furthest node in the list of candidate nearest neighbors plus an overlapping factor. The rule set can also include a rule for pruning siblings of a node inserted into the list of candidate nearest neighbors if a parent of the node meets the validity test for pruning. The steps of searching, generating and pruning for each level of the tree can be repeated until a termination condition is met. Once the termination condition is met, the list of candidate nearest neighbors can be provided as output.

Another embodiment provides a computer system for searching a metric space. The computer system can include a processor, and a memory. The memory can have software instructions stored therein such that the instructions, when executed, cause the computer system to perform a series of steps. The steps can include building a tree data structure representing a database and providing the metric space. The tree can include one or more nodes each having a cluster of one or more data points. Each cluster can have a center data point.

The steps can also include searching the tree to locate a number of nearest neighbors to a query point by determining a metric distance from each center data point to the query point, and generating a list of candidate nearest neighbors to the query point during the searching. The list of candidate nearest neighbors can be used to determine whether portions of the tree should be searched.

The steps can also include pruning a portion of the tree according to a rule set so as to eliminate the portion of the tree from being considered for further searching, the rule set including a validity test for pruning a node of the tree that is further away from the query point than a distance in metric space represented by a furthest node in the list of candidate nearest neighbors plus an overlapping factor. The steps of searching, generating and pruning steps can be repeated for each level of the tree until a termination condition is met. Once the termination condition is met, the list of candidate nearest neighbors can be provided as output.

Another embodiment provides a computer program product for conducting a search in a metric space. The computer program product can include a computer usable medium and computer readable program code physically embodied on the computer usable medium. The computer readable program code can be constituted by instructions that, when executed by a computer, cause the computer to perform a series of steps. The steps can include building a tree data structure representing a database and providing the metric space. The tree can include one or more nodes each having a cluster of one or more data points. Each cluster can have a center data point. During the building of the tree nodes on one level of the tree can be permitted to overlap by containing mutual data points so long as an overlapping portion does not exhaust a metric subspace on that level.

The steps can also include searching the tree, one level at a time in a breadth-first manner, to locate a number of nearest neighbors to a query point by determining a metric distance from each center data point to the query point, and generating a list of candidate nearest neighbors to the query point during the searching. The steps can also include using the list of candidate nearest neighbors to determine whether a portion of the tree is to be searched, and pruning the tree if it is determined that the portion should not be searched. The steps can also include storing the list of candidate nearest neighbors as output once a termination condition is met.

Another embodiment can include a method for performing a nearest neighbor search of a metric space. The method may include generating a data tree structure that represents an underlying distribution or geometry of data. Portions of the data tree can be pruned before the metric space search to potentially make the search quicker or more efficient. The method may include dynamically comparing the query point to the data elements as the tree is pruned, so that the search is completed substantially contemporaneously with the pruning process.

### BRIEF DESCRIPTION OF THE DRAWINGS

FIG. 1 shows a flowchart of an exemplary embodiment of a method for searching a metric space;

FIG. 2 shows a diagram of an exemplary tree data structure;

FIG. 3 shows a flowchart for an exemplary embodiment of a method for building and pruning a search tree;

FIG. 4 shows a flowchart of exemplary method for building a tree data structure;

FIG. 5 shows a flowchart of an exemplary embodiment of a method for searching a tree data structure; and

FIG. 6 shows a block diagram of an exemplary embodiment of a computer system for performing a metric space.

### DETAILED DESCRIPTION

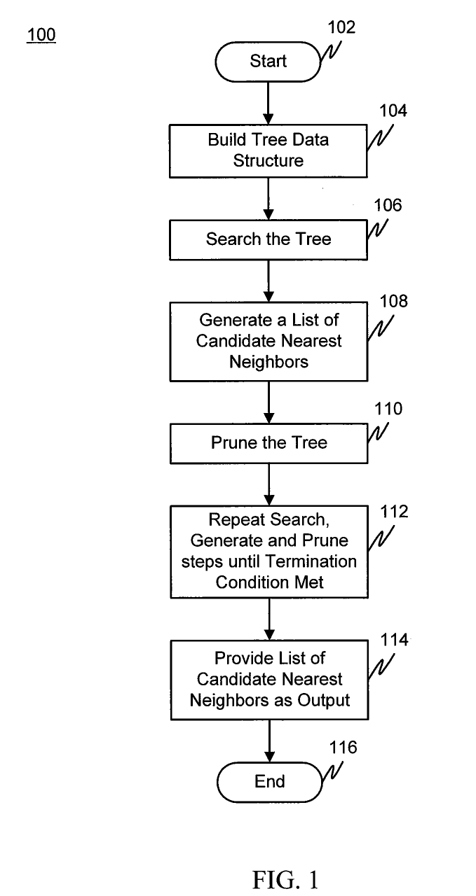

FIG. 1 shows a flowchart 100 of an exemplary embodiment of a method for searching a metric space. In particular, control for the method begins at step 102 and continues to step 104.

In step 104, a tree data structure is built. For example, a tree structure can be generated that represents the distribution of the underlying metric space data. One or more data elements (center data points or medoids) can be selected that are the furthest metric distances from each other. Then, the remaining data elements are formed into nodes or groups of elements, or clusters, around each center data point. Each data element can be put into the group corresponding to its nearest parent in metric distance. This grouping of nearest elements, or siblings, is then repeated recursively with each of the nodes, and each successive node, until the metric space is divided into nodes having small groups of data comprising the neighbors that have the nearest metric distances to each other.

Alternatively, the branched groupings of the tree can ultimately be divided down to individual data elements, or leaf nodes containing a group of one. Each divided node is a subset of its larger node, or parent. The subset nodes of the parent are children of the parent and siblings of each other. The number of nodes to be divided at each level can be arbitrarily chosen. Alternatively, the number of nodes can be selected based on a desired tradeoff of computational speed and accuracy. The data tree may be structured with a plurality of levels. Any node can consist of one or more data points. Control continues to step 106.

In step 106, the tree data structure is searched. For example, a query point can be provided and the metric distance of each parent node to the query point can be calculated. A metric can be generated that is characteristic of each node. Alternatively, the medoid metric can be used. Alternatively, the metric of the parent node can be used. The number of nearest neighbors (k nearest neighbors or KNN) to be located can be specified. The nodes can be searched for the KNN. The k number of nodes that are nearest to the query point can be kept, and the other nodes can be pruned away, or excluded from the subsequent search, as described below. Control continues to step 108.

Also, a search for more than one query point may be conducted simultaneously, or for multiple dimensions of a given query point. A non-limiting example is searching a metric space of images for both color and shape for neighbors nearest to the query point. The query point can also represent one or more characteristics, variables, dimensions, or metric distances to be searched in the metric space.

In step 108, a list of candidate nearest neighbors is generated. For example, the KNN determined after pruning (described below) can be stored on a k nearest neighbor list, which can be updated dynamically. The children of the one or more KNN nodes that have not been pruned can be screened for pruning. The pruning process described below can be repeated for the children of the nodes on the KNN list. If any of the children nodes fall outside of the specified number of nearest neighbors (or a larger multiple based on distance), that node and its children and siblings can be pruned. The remaining node is searched for nearest neighbors, and a new list of KNN can be compiled. The pruning and searching process at this child level results in an updated k nearest neighbor list with some of the children at this level excluded. This method of pruning and searching is then repeated for each subsequent level of the tree, resulting in a dynamically updated KNN list as it proceeds. The pruning can be based on numerical values, metric distances, geometric properties of the search tree, and/or the like.

When nodes are identified that are nearest to the query point, these nodes can be searched for the k nearest neighbors to the data point. Alternatively, the search can be completed after a specified amount of pruning. Alternatively, the pruning can be completed right down to the level of individual data elements, where the remaining data elements will be the k nearest neighbor data points desired. It is possible to have a hybrid method, whereby dynamically updated pruning and searching is done for parts of the tree, followed by traditional searching, or vice versa. It is also possible to change the number of desired KNN to be updated to the list at each level of the tree pruning. Control continues to step 110.

In step 110, the tree is pruned. For example, as mentioned above, the k number of nodes that are nearest to the query point can be kept, and the other nodes can be pruned away, or excluded from the subsequent search. Alternatively, fewer nodes can be pruned away, leaving more than the k number of nodes to be searched. This could be accomplished by specifying a pruning criterion, beyond which nodes are pruned away and excluded from the search. One possible pruning criterion is to prune away nodes a further distance from the query point than some multiple of the furthest KNN. Alternatively, all nodes furthest nodes could be pruned besides k+n nearest neighbors.

It may be possible that an individual child node, element, or data point that is a nearest neighbor gets pruned. The extent of this possibility, and, therefore, the accuracy of the method, can be a tradeoff between the speed and efficiency of the search, versus the accuracy of the search. It may be possible to derive an optimum tradeoff of: speed, efficiency, and/or accuracy by adjusting one or more parameters such as number of nodes, number of parents, number of children in each level, target metric distance at each level, how the metric distance from the query point to a node is calculated, and the method of the metric space search, based on the inherent characteristics of the metric space and the type of search performed. This is largely a function of the number of nodes held for KNN searching after pruning, or a pruning criterion. The pruning criterion can be, for example, a multiple of the distance of the furthest KNN, or as k+n nodes. The pruning criterion can be adjusted for optimum performance and can be changed dynamically throughout the pruning and searching process for subsequent levels. The pruning criterion may simply be the number of KNN.

The above pruning process also can be used to eliminate each subsequent level of children and/or siblings within a node, by pruning not only a metric node or data point, but also all subsequent levels attached to this data point. Alternatively, the pruning could be performed only at the current level. Control continues to step 112.

In step 112, steps 106-108 may each be repeated as desired until a termination condition is met. For example, steps 106-108 can be repeated for each subsequent level of a search tree. Control continues to step 114.

In step 114, the list of candidate nearest neighbors may be provided as output. The output list can be stored in a memory, stored on a computer usable medium, transmitted to another device, displayed on a display device, printed, output as audio and/or video, provided as input to another process or program, or the like. Control continues to step 116, where the method ends.

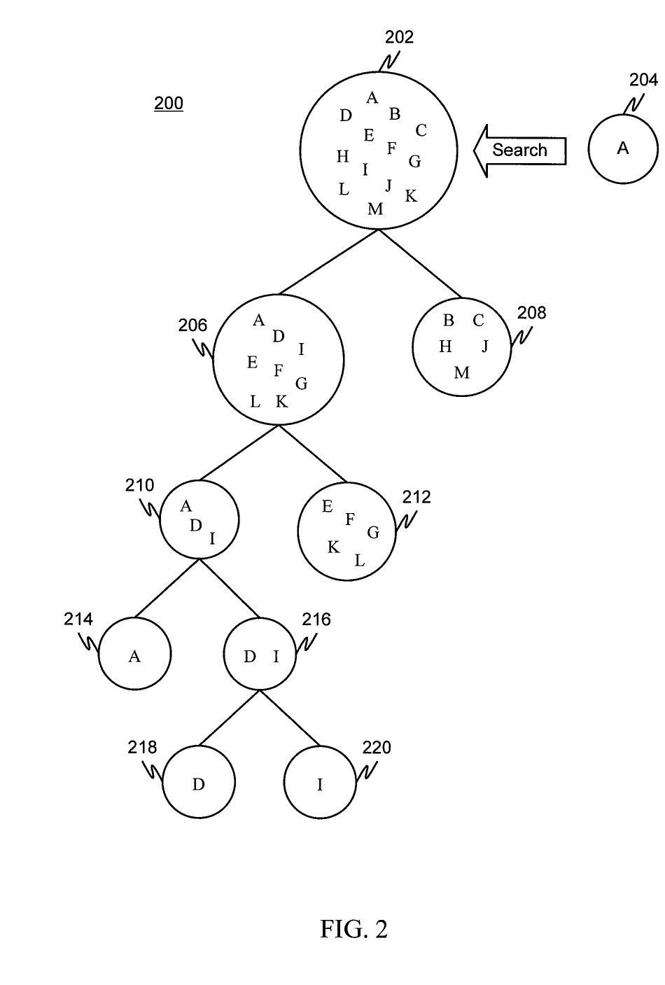

FIG. 2 shows a diagram of an exemplary tree data structure. In particular, metric space data 200 may be populated with a number of data elements 202 and a query point 204 may be provided. The objective of the search in this example is to find the one nearest neighbor to query point 204. A number, in this example two, of disparate data elements, based on metric distance (amongst the data elements, or, alternatively, relative to the query point 204), may be identified and separated. The data elements nearest to these two points may then be associated into two nodes, 206 and 208. Each node contains multiple data points. The center point of node 206 is closer to the query point 204 that the center data point of node 208. So, node 208 may be pruned, or eliminated from consideration for further searching. Thus, time and computation cycles can be saved by not having to search node 208 or its children. The procedure may be repeated, treating node 206 as a parent node, resulting in children nodes 210 and 212. [0031] Because the center point of node 212 is further from the query point than the center point of node 210, node 212 can be pruned. The two most disparate data elements in node 210, based on metric distance to the query point 204, may be identified and separated. The data elements nearest to these two points may then be associated into two children nodes, 214 and 216. Because the center point of node 216 is further from the query point 204 than the center point of node 214, node 216 can be pruned. Thus, node 214, which contains only one data point, is the nearest neighbor to the query point 204. The search can be terminated because a node has been reached that contains a leaf node, or a node with a single data point.

Other termination conditions could be used. For example, the search could terminate when a hyper-level is reached. A hyper-level is a level of the tree having nodes whose children are all leaf nodes.

The method can include options as to when to perform the nearest neighbor search and how far to prune the tree. The metric space search could be done on node 206, and time would be saved by not having to search node 208. Alternatively, node 210 can be searched after pruning nodes 208 and 212 and all subsequent children and siblings. Alternatively, the tree can be structured and pruned down to node 214, the nearest neighbor.

This example is illustrative of one embodiment of the method. The method could also be applied using n parent nodes and searching for k nearest neighbors, as well. The method could also be performed while searching multiple metrics distances or data characteristics.

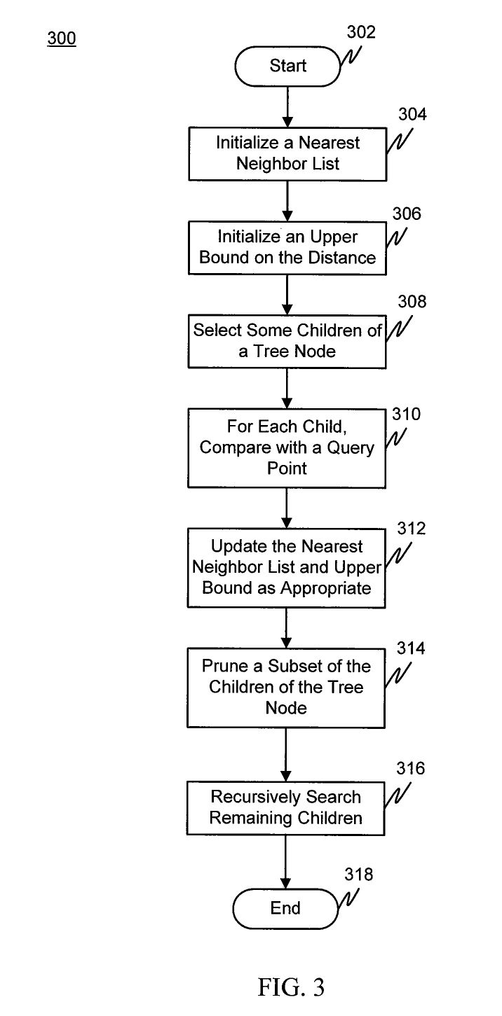

FIG. 3 shows a flowchart 300 for an exemplary embodiment of a method for building and pruning a search tree. In particular, control for the method begins at step 302 and continues to step 304.

In step 304, a nearest neighbor list is initialized. The nearest neighbor list can be initialized for a predetermined number of nearest neighbors. Initialization can include steps necessary to prepare a list data structure for use, such as clearing memory, setting flags or counters, or the like. Control continues to step 306.

In step 306, an upper bound on distance is initialized. The upper bound on distance can represent a metric distance that is an upper limit and any nodes further from the query point than the upper bound can be pruned. Control continues to step 308.

In step 308, some children of a tree node are selected. The number of children selected can be hard-coded, received as input from another processor or from a configuration file, for example. The number of children selected can vary from none to all of the children. The node can be the root node of the tree. The number selected can be based on a desired trade-off between accuracy and performance. Control continues to step 310.

In step 310, each child node selected in step 308 is compared with the query point and a metric distance is determined. The metric distance can be based on one or more direct or derived characteristics of the node. Control continues to step 312.

In step 312, the nearest neighbor list and the upper bound can be updated as appropriate. For example, the nearest neighbor list may be updated when a node is located that is as near, or nearer, to the query point as the nodes on the list. Also, the upper bound can be updated in response to the proximity of the nodes on the nearest neighbor list to the query point. For example, if the nodes on the nearest neighbor list are tending to become closer to the query point, the upper bound may be lowered to prune more of the tree off and thus potentially speed up the search. The upper bound can be lowered because the likelihood of finding a better nearest neighbor in a node that is further away from the query point than the nodes on the list may be possible, but may not be likely depending on the various tolerances, overlapping factors and other parameters being used. Control continues to step 314.

In step 314, a subset of the children nodes are pruned. Those nodes that meet the pruning criteria may be pruned, or removed from being considered for further searching. For example, pruning criteria, or rule set, can include a validity test for pruning a node of the tree that is further away from the query point than a distance in metric space represented by a furthest node in the list of candidate nearest neighbors plus an overlapping factor. Also, the pruning criteria, or rule set, can include pruning siblings of a node inserted into the list of candidate nearest neighbors if a parent of the node meets the validity test for pruning. Control continues to step 316.

In step 316, the remaining children nodes are recursively searched and/or pruned using steps 308-316 as described above. A termination condition for the recursion can be reached and the list of candidate nearest neighbors can be provided in whole or in part as output. Once the termination condition for the recursion has been reached, control continues to step 318 where the method ends.

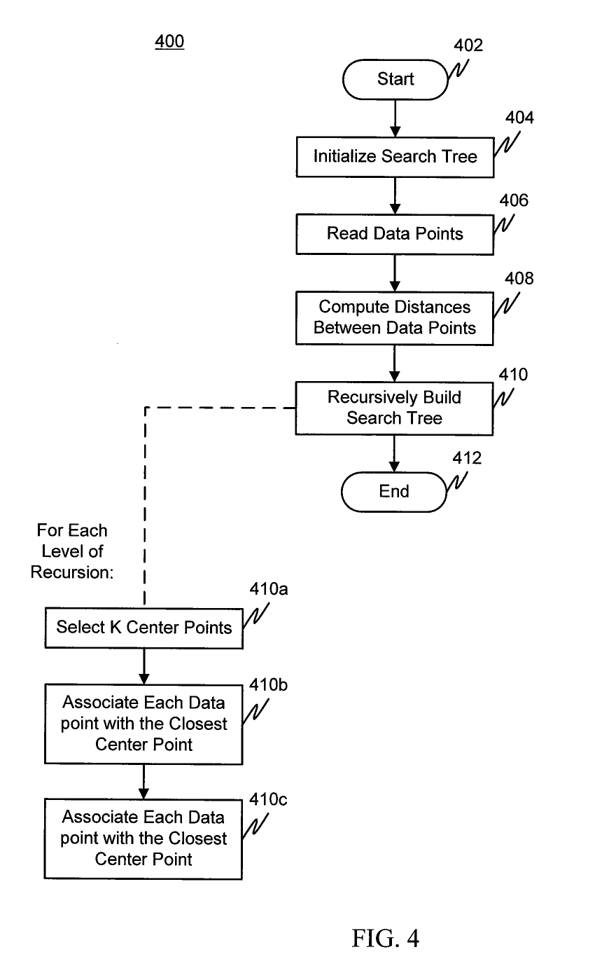

FIG. 4 shows a flowchart 400 of exemplary method for building a tree data structure. In particular, the method begins at step 402 and continues to step 404.

In step 404, a search tree is initialized. Initialization can include steps necessary to prepare the search tree data structure for use, such as clearing memory, setting flags or counters, or the like. Control continues to step 406.

In step 406, data points are read in as input. The data points can represent items in a database, such as images. Control continues to step 408.

In step 408, a metric distance between the data points in computed. The metric distance can be computed from one or more direct or derived characteristics of a data point. Control continues to step 410.

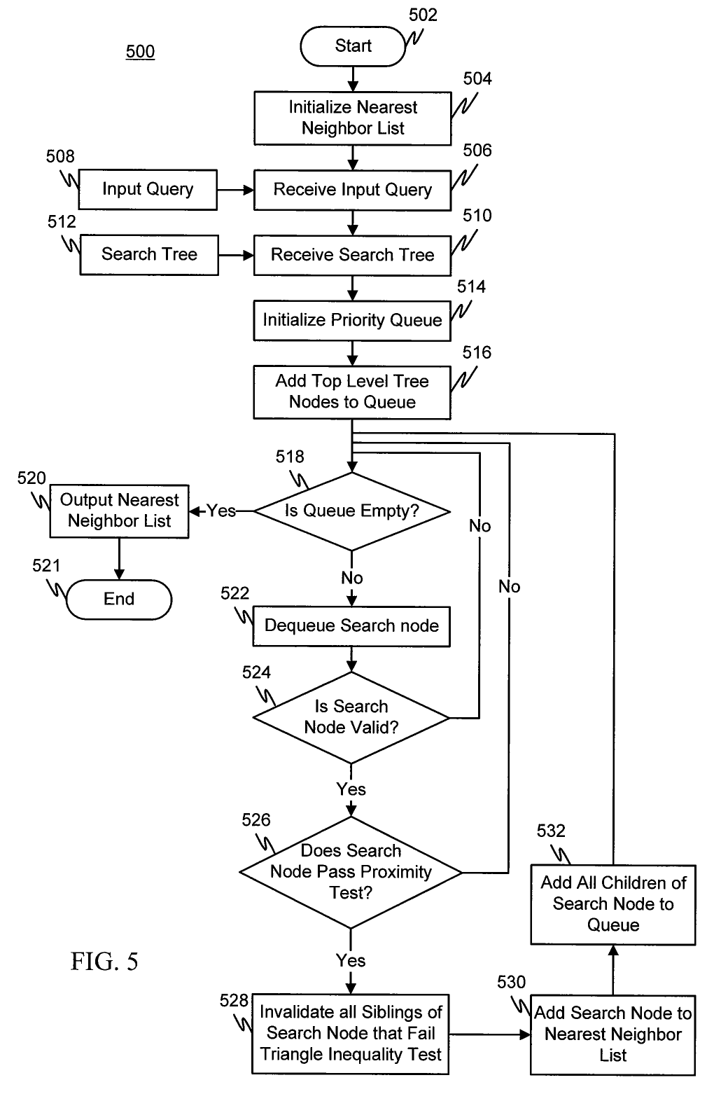

In step 410, the search tree is built recursively. Step 410 includes steps 410a-410c. Steps 410a-410c can be repeated for each level of recursion, e.g., for each level of the tree being built. Alternatively, data further than a desired metric distance from the query point may be pruned tree during the building of each level. Pruning may be performed either in parallel with the tree building process, contemporaneously with it, or it may be performed serially. In yet another alternative, the tree can be built with only one application of the three steps, without any recursion. The search tree can be stored, transmitted, or provided as output, for use by another system or process. The completed tree may then be searched with a metric data tree search method, for example as described below in conjunction with FIG. 5. The data search may be performed in parallel with the data tree building and pruning method, or it can be performed after the tree is built. Alternatively, a data tree can be searched, then the recursive data tree rebuilding process can be repeated, and the rebuilt tree searched.

In step 410a, a number (K) of medoids are selected. The medoids may be an actual center point (medoid), or may be a computed center point (mean). The medoids may be selected at random or according to one or more designated criteria. Control continues to step 410b.

In step 410b, each data point is associated with the closest (or nearest) center point. For example, each data point may be associated with the medoid that is closest in metric distance, creating a data group, or cluster, around that medoid. Control continues to step 410c.

In step 410c, statistics for the cluster of data points surrounding each center point are computed. These statistics can include, for example, the metric distance to the nearest data points in other data groups, and the data group radius, indicating the furthest distances of the data points within a group, or the like.

The recursion can terminate using a variety of criteria, such as including all of the data points in the tree, reaching the leaf nodes of the data elements, having traversed a given number of levels, having examined a given number of data points, or the like. Once the recursion has terminated, control continues to step 412, where the method ends.

FIG. 5 shows a flowchart 500 of an exemplary embodiment of a method for searching a tree data structure. In particular, control for the method begins at step 502 and continues to step 504.

In step 504, a nearest neighbor list is initialized. Initialization can include steps necessary to prepare the nearest neighbor list data structure for use, such as clearing memory, setting flags or counters, or the like. Control continues to step 506.

In step 506, an input query is received. The input query may be received from an internal or external source. For example, the input query could be an image, or a portion of an image, such as a human face, a fingerprint, an eye, handwritten or machine printed text, a threat scanning machine image, or the like. A threat scanning image can be derived from threat scanning equipment such as an x-ray or other imaging or sensing device. The image may be of a piece of baggage, a cargo container, or the like. Control continues to step 510.

In step 510, a search tree is received. The search tree may have been pre-generated and stored or may be generated in response to a request to search the database for the query point. Control continues to step 514.

In step 514, a priority queue is initialized. The priority queue has elements prioritized according to their respective distances in metric space from the query point. For example, those elements with smaller distances have higher priority in the queue. Control continues to step 516.

In step 516, top-level tree nodes are added to the priority queue. This starts the search at the top level of the tree. Of course, other starting levels may be used depending on desired operation. Control continues to step 518.

In step 518, it is determined whether the priority queue is empty or not. The queue being empty signals a termination condition for the search because, presumably, all nodes of interest have been evaluated. If the queue is empty control continues to step 520. Otherwise, control continues to step 522.

In step 520, the nearest neighbor list is made available as output. The output list can be stored in a memory, stored on a computer usable medium, transmitted to another device, displayed on a display device, printed, output as audio and/or video, provided as input to another process or program, or the like. Control continues to step 521, where the method ends.

In step 522, a search node is de-queued from the priority queue. The search node is removed from the queue and evaluated as described below. Control continues to step 524.

In step 524, the search node is checked for validity. The node may have been invalidated during a prior test. If the search node is valid, control continues to step 526. Otherwise, control returns to step 518.

In step 526, it is determined whether the search node passes the proximity test of the pruning rule set. The proximity test compares the search node to the elements in the nearest neighbor list. The proximity test is passed if the distance from the search node to the query point is less than the maximum distance from any node in the nearest neighbor list to the query point, plus a factor. If the search node passes the proximity test, control continues to step 528. Otherwise, control returns to step 518.

In step 528, all siblings of the search node that fail the triangle inequality test are invalidated. The triangle inequality test compares the distance from the search node to the query point to the range of possible distances of the search node to its siblings. If the distance from the search node to the query point does not fall in the range of distances from the search node to the data points in a sibling cluster, the sibling cluster fails the test and is invalidated. Control continues to step 530.

In step 530, the search node is added to the nearest neighbor list. Control continues to step 532.

In step 532, all children of the search node are added to the priority queue and control returns to step 518.

In the various embodiments of the methods described above, some or all of the steps may be repeated as desired to achieve a contemplated searching process.

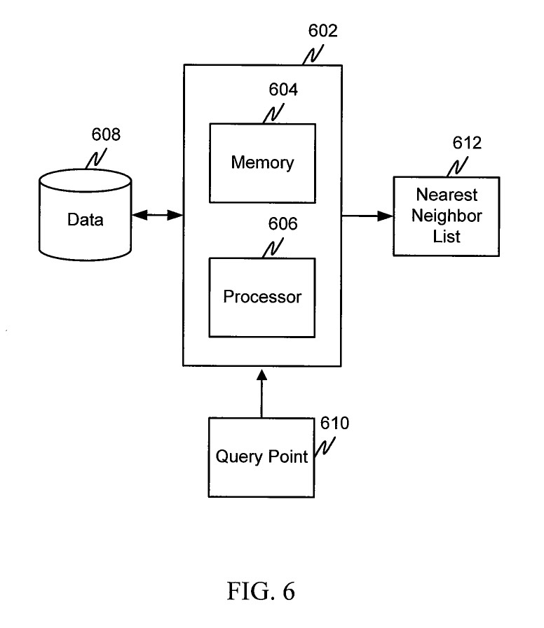

FIG. 6 shows a block diagram of an exemplary embodiment of a computer system for performing a metric space. In particular, a computer system 602 includes a memory 604 and a processor 606. A database 608 provides data storage for the computer system. The computer system receives as input a query point 610 and provides as output a nearest neighbor list 612.

In operation, the computer system 602 may receive a query point 610. The computer system, using a method as described above, can build a search tree and search for the query point 610 in the database 608. The computer system 602 may provide the nearest neighbor list 612 as output.

The memory 604 is operable to store computer readable program instructions (e.g., software) for performing predetermined steps. The processor 606 is operable to execute the computer readable instructions. Although the query point 610 and the nearest neighbor list 612 are shown as external to the computer system 602, it should be appreciated that these may alternatively be internal to the computer system 602.

The computer system may be a standalone system, or part of larger system such as a postal address recognition system, a threat scanning system, a search engine, or other system where a metric space search is desirable.

The described metric space search tree generation, pruning, and search methods could be used for a variety of complex data search problems, such as image searches for a variety of image characteristics, facial recognition, optical character recognition for handwritten or printed text, pattern recognition, machine learning, database querying, data mining, text image searching, searching text documents, and image based threat detection searches. An embodiment could also be embedded into a larger software program or operate as a stand-alone component, or service, accessible by another computer system or process.

The method for tree pruning and searching for nearest neighbors in metric spaces, exemplary embodiments of which are described above and shown in the figures, may be implemented on a general-purpose computer, a special-purpose computer, a programmed microprocessor or microcontroller and peripheral integrated circuit element, and ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions or steps described herein may be used to implement the method for tree pruning and searching for nearest neighbors in metric spaces according to this invention.

Furthermore, the disclosed method for tree pruning and searching for nearest neighbors in metric spaces may be readily implemented, fully or partially, in software using, for example, object or object-oriented software development environments that provide portable source code that can be used on a variety of computer platforms. Alternatively, the disclosed method for tree pruning and searching for nearest neighbors in metric spaces may be implemented partially or fully in hardware using, for example, standard logic circuits or a VLSI design. Other hardware or software can be used to implement embodiments in accordance with this invention depending on the speed and/or efficiency requirements of the systems, the particular function, and/or a particular software or hardware system, microprocessor, or microcomputer system being utilized. The method for tree pruning and searching for nearest neighbors in metric spaces illustrated herein can readily be implemented in hardware and/or software using any known or later developed systems or structures, devices and/or software by those of ordinary skill in the applicable art from the functional description provided herein and with a general basic knowledge of the computer, data structure, and search arts.

Moreover, the disclosed method for tree pruning and searching for nearest neighbors in metric spaces may be readily implemented in software executed on programmed general-purpose computer, a special purpose computer, a microprocessor, or the like. In these instances, the method of this invention can be implemented as a program embedded on a personal computer such as a JAVA® or CGI script, as a resource residing on a server or graphics workstation, as a routine embedded in a dedicated encoding/decoding system, or the like. The method and system can also be implemented by physically incorporating an embodiment of the method for metric space search tree pruning and/or searching for nearest neighbors in metric spaces into a software and/or hardware system, such as the hardware and/or software systems of mail sorting equipment, an internet search engine, fingerprint matching equipment, biometric equipment, text or image matching equipment, pattern detection/recognition equipment, or threat scanning equipment, for example.

It is, therefore, apparent that there is provided, in accordance with the present invention, a method, computer system, and computer program product for pruning and searching for approximate nearest neighbors in metric spaces. While this invention has been described in conjunction with a number of embodiments, it is evident that many alternatives, modifications and variations would be or are apparent to those of ordinary skill in the applicable arts. Accordingly, applicant intends to embrace all such alternatives, modifications, equivalents and variations that are within the spirit and scope of this invention.

What is claimed is:

1. A method for searching a metric space, the method comprising:
building a tree data structure that represents a database and provides the metric space, the tree including one or more nodes each having a cluster of one or more data points, each cluster having a center data point, the nodes on one level of the tree being permitted to overlap by containing mutual data points so long as an overlapping portion does not exhaust a metric subspace on that level of the tree;
searching the tree, one level at a time in a breadth-first manner, to locate a number of nearest neighbors to a query point by determining a metric distance from each center data point to the query point;
generating a list of candidate nearest neighbors to the query point during the searching and using the list of candidate nearest neighbors to determine whether portions of the tree should be searched;
pruning the tree according to a rule set so as to eliminate a portion of the tree from being considered for further searching, the rule set including a validity test for pruning a node of the tree that is further away from the query point than a distance in metric space represented by a furthest node in the list of candidate nearest neighbors plus an overlapping factor, the rule set also including pruning siblings of a node inserted into the list of candidate nearest neighbors if a parent of the node meets the validity test for pruning;
repeating the searching, generating and pruning steps for each level of the tree until a termination condition is met; and
providing the list of candidate nearest neighbors as output once the termination condition is met.

2. The method of claim 1, further comprising updating the list of candidate nearest neighbors so the list contains only a predetermined number of nodes having the least metric distances from the query point.

3. The method of claim 1, wherein the metric distance is determined using a single data point characteristic.

4. The method of claim 1, wherein the metric distance is determined using multiple data point characteristics.

5. The method of claim 1, further comprising communicating the output to a mail sorting system.

6. The method of claim 1, further comprising communicating the output to a threat scanning system.

7. The method of claim 1, further comprising communicating the output to a biometric image matching system.

8. A computer system for searching a metric space, the computer system comprising:
a processor, and
a memory including software instructions that, when executed, cause the computer system to perform the steps of:
building a tree data structure representing a database and providing the metric space, the tree including one or more nodes each having a cluster of one or more data points, each cluster having a center data point;
searching the tree to locate a number of nearest neighbors to a query point by determining a metric distance from each center data point to the query point;
generating a list of candidate nearest neighbors to the query point during the searching and using the list of candidate nearest neighbors to determine whether portions of the tree should be searched;
pruning a portion of the tree according to a rule set so as to eliminate the portion of the tree from being considered for further searching, the rule set including a validity test for pruning a node of the tree that is further away from the query point than a distance in metric space represented by a furthest node in the list of candidate nearest neighbors plus an overlapping factor;
repeating the searching, generating and pruning steps for each level of the tree until a termination condition is met; and
providing the list of candidate nearest neighbors as output once the termination condition is met.

9. The computer system of claim 8, wherein the nodes on one level of the tree being permitted to overlap by containing mutual data points so long as an overlapping portion does not exhaust a metric subspace on that level.

10. The computer system of claim 8, wherein the tree is searched one level at a time in a breadth-first manner.

11. The computer system of claim 8, wherein the rule set further includes pruning siblings of a node inserted into the list of candidate nearest neighbors if a parent of the node meets the validity test for pruning.

12. A computer program product for conducting a search in a metric space, the computer program product comprising:
a computer usable medium; and
computer readable program code physically encoded on the computer usable medium, the computer readable program code constituted by instructions that, when executed by a computer, cause the computer to perform steps comprising:
building a tree data structure representing a database and providing the metric space, the tree including one or more nodes each having a cluster of one or more data points, each cluster having a center data point, the nodes on one level of the tree being permitted to overlap by containing mutual data points so long as an overlapping portion does not exhaust a metric subspace on that level;
searching the tree, one level at a time in a breadth-first manner, to locate a number of nearest neighbors to a query point by determining a metric distance from each center data point to the query point;
generating a list of candidate nearest neighbors to the query point during the searching;
using the list of candidate nearest neighbors to determine whether a portion of the tree is to be searched;
pruning the tree if it is determined that the portion should not be searched; and
storing the list of candidate nearest neighbors as output once a termination condition is met.

13. The computer program product of claim 12, further comprising repeating the searching, generating and pruning steps for each level of the tree until the termination condition is met.

14. The computer program product of claim 12, wherein the step of pruning the tree further includes using a rule set including a validity test for pruning a node of the tree that is further away from the query point than a distance in metric space represented by a furthest node in the list of candidate nearest neighbors plus an overlapping factor.

15. The computer program product of claim 14, wherein the step of pruning the tree further includes pruning siblings of a node inserted into the list of candidate nearest neighbors if a parent of the node meets the validity test for pruning.

16. The computer program product of claim 12, wherein the metric distance is determined using a single data point characteristic.

17. The computer program product of claim 12, wherein the metric distance is determined using multiple data point characteristics.

18. The computer program product of claim 12, wherein the termination condition includes reaching a hyper-level of the tree.

19. The computer program product of claim 12, wherein termination condition includes reaching a level of the tree containing a leaf node.

20. The computer program product of claim 12, wherein the computer readable program code is configured to search a database containing images.
